(19) United States
(12) Patent Application Publication
(10) Pub. No.: US 2012/0153720 A1
(43) Pub. Date: Jun. 21, 2012

(54) POWER SYSTEM FOR CONTAINER DATA CENTER

(75) Inventors: KUO-HSIANG CHANG, Tu-Cheng (TW); TE-MING CHANG, Tu-Cheng (TW)

(73) Assignee: HON HAI PRECISION INDUSTRY CO., LTD., Tu-Cheng (TW)

(21) Appl. No.: 13/089,314

(22) Filed: Apr. 19, 2011

(30) Foreign Application Priority Data
Dec. 20, 2010 (TW) 99144747

(51) Int. Cl. H02J 9/06; H02J 7/34

(52) U.S. Cl. 307/23; 307/48

(57) ABSTRACT

A power system for a container data center includes an interruptible power supply, a power supply unit and a storage capacitor. The uninterruptible power supply rectifies the inputted AC voltage to a DC voltage output. The power supply unit converts the DC output voltage to a suitable voltage for a load. The storage capacitor is connected between the input terminal of power supply unit and the ground, and placed outside of the power supply unit.

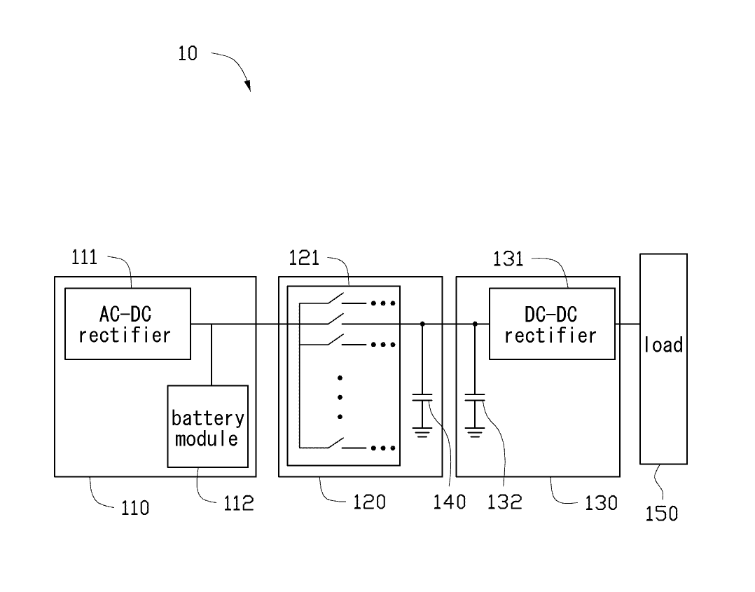

### TECHNICAL FIELD

The disclosure generally relates to a power system, and more particularly to a power system for a container data center.

### DESCRIPTION OF RELATED ART

Container data centers are facilities that provide computing services to enterprise businesses. When designing a container data center the power utilization efficiency (PUE) must be taken into consideration. However, in many cases, components inside the power units of the power system powering the container data center are not positioned with air cooling in mind during the design process. Thus the larger components inside the power units may affect the air flow inside the power units and decrease heat dissipation efficiency.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure.

The drawing is an illustrative power system for a container data center in accordance with an embodiment.

### DETAILED DESCRIPTION

Embodiments of a power system will now be described in detail below and with reference to the drawing.

Referring to the drawing, a power system 10 for a container data center in accordance with an embodiment is provided. The power system 10 includes an uninterruptible power supply 110, a power distribution unit 120, a power supply unit 130, a storage capacitor 140 and a load 150.

The uninterruptible power supply 110 includes an AC-DC rectifier 111 and a battery module 112. The AC-DC rectifier 111 rectifies an input AC voltage to an output DC voltage. A root mean square (RMS) value of the input AC voltage is between 400V and 480V. The output DC voltage is between 320V and 400V. The battery module 112 is connected to an output terminal of the AC-DC rectifier 111. When the input AC voltage is down or is no longer being supplied, the battery module 112 may continue to provide operating power so that circuits after the uninterruptible power supply 110 will continue to work without interruption. In an alternative embodiment, the battery module 112 can be back-up batteries. When the input AC voltage is normal, the AC-DC rectifier 111 will charge the battery module 112.

The power distribution unit 120 includes a switch device 121. An input terminal of the switch device 121 is connected to the output terminal of the AC-DC rectifier111. By turning on (or off) the switch device 121, the interruptible power supply 110 will selectively power the power supply unit 130 (or not). In this embodiment, the switch device 121 includes several switch units, and each switch unit controls a power supply unit 130. The storage capacitor 140 is formed inside the power distribution unit 120. In alternative embodiments, the uninterruptible power supply 110 can be connected to the power supply unit 130 directly. In that condition, the storage capacitor 140 can be inside the uninterruptible power supply 110.

The power supply unit 130 includes a DC-DC rectifier 131 and a filter capacitor 132. An input terminal of the DC-DC rectifier 131 is connected to the output terminal of the switch device 121. The DC-DC rectifier 131 converts the output voltage of the switch device 121 to a suitable voltage for the load 150. The output voltage of the DC-DC rectifier 131 can be 5V or 12V. The load 150 can be a hard disk, a central processing unit or memory chips such as RAM chips in the container data center. One end of the filter capacitor 132 is connected to the input terminal of the power supply unit 130; the other end of the filter capacitor 132 is connected to ground. In general, the ripple voltage is about 1% of the input voltage. That is, when an input voltage of the power supply unit is 400V, the ripple voltage needs to be less than 4V with respect to the filter capacitor 132.

The storage capacitor 140 is connected between the input terminal of the power supply unit 130 and ground. After the power system 10 shuts down normally, the storage capacitor 140 will provide a buffer time (such as 20 ms) for elements in the load 150 to power down. However, the function of the storage capacitor 140 is not the same as the battery module 112. The battery module 112 provides power for the load 150 to continue to work for several tens of minutes or even several hours. But the storage capacitor 140 provides power for the load 150 to normally shut down in a short time, such as 20 ms.

The capacitance C_{hold} of the storage capacitor 140 can be calculated by the following equation:

$$\frac{{P}_{out}}{Eff} * {T}_{hold} = \frac{1}{2} * {C}_{hold} * ( {V}_{in - normal}^{2} - {V}_{in - min}^{2} ) \qquad ( 1 )$$

In equation (1), Vᵢₙ₋ₙₒᵣₘₐₗ is the input voltage; Vᵢₙ₋ₘᵢₙ is the lowest working voltage; Pₒᵤₜ is the output power; Eƒƒ is the transformer efficiency; T_{hold} is the buffer time for shut down.

Rearranging equation (1) gives:

$${C}_{hold} = \frac{{P}_{out}}{Eff} * \frac{2 * {T}_{hold}}{( {V}_{in - normal}^{2} - {V}_{in - min}^{2} )} \qquad ( 2 )$$

When Vᵢₙ₋ₙₒᵣₘₐₗ=400V; Vᵢₙ₋ₘᵢₙ=320V; Pₒᵤₜ=900 W; Eƒƒ=0.97; T_{hold}=20 ms, C_{hold}=644.3 μF is obtained. Considering the nominal capacitance and its deviation, we choose a capacitor of 680 μF/420V as the storage capacitor 140.

The capacitance Cᵢₙ of the filter capacitor 132 can be calculated using the following equation:

$$Δ {V}_{cin} = \frac{{I}_{in} * ( D - {D}^{2} ) * {T}_{s}}{{C}_{in}} = \frac{{I}_{out} * {N}_{s}}{2 {N}_{p}} * \frac{( D - {D}^{2} ) * {T}_{s}}{{C}_{in}} \qquad ( 3 )$$

In equation (3), ΔV_{cin}, is the ripple input voltage; Iᵢₙ is the input current; Tₛ is the transformer period of the switch; Iₒᵤₜ is output current; Nₚ is the number of primary turns; Nₛ is the number of secondary turns; D is the duty cycle.

In this embodiment, ripple input voltage is 1% of the input voltage V_{in. When V}ᵢₙ=400V, 1/Tₛ=140 kHz, Nₛ=2, Nₚ=40, Iₒᵤₜ=75 A, D=0.375, the Cᵢₙ can be calculated in following:

$${C}_{in} = \frac{{I}_{out} \times {N}_{s}}{2 \times {N}_{p}} \times \frac{( D - {D}^{2} ) \times {T}_{s}}{Δ {V}_{cin}} = \frac{{I}_{out} \times {N}_{s}}{2 \times {N}_{p}} \times \frac{( D - {D}^{2} ) \times {T}_{s}}{{V}_{in} \times 1 \%}$$

Cᵢₙ=0.78 μF is obtained. Considering the nominal capacitance and its deviation, we choose a capacitor of 1 μF/450V as the filter capacitor 132.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power system for a container data center, comprising:
an interruptible power supply comprising an AC-DC rectifier for converting an input AC voltage to an output DC voltage;
a power supply unit comprising a DC-DC rectifier, an input terminal of the DC-DC rectifier being connected to an output terminal of the interruptible power supply and converting the output voltage of the interruptible power supply to a voltage suitable for a load; and
a storage capacitor connected between the input terminal of the power supply unit and ground, and placed outside of the power supply unit.

2. The power system of claim 1, wherein the interruptible power supply further comprises a battery module, the batter module is connected to the output terminal of the DC-DC rectifier to provide electrical power to the load when input AC voltage is in fault condition.

3. The power system of claim 2, wherein the battery module is a back-up battery, the AC-DC rectifier charges the battery module when the AC voltage is in normal condition.

4. The power system of claim 2, wherein the battery module comprises several battery cells in parallel connection.

5. The power system of claim 1, further comprising a power distribution unit to selectively connect the uninterruptible power supply with the power supply unit.

6. The power system of claim 5, wherein the storage capacitor is placed inside the power distribution unit.

7. The power system of claim 6, wherein the power distribution unit comprises a switch device connected between the uninterruptible power supply and the power supply unit, the storage capacitor is connected between the output terminal of the switch device and ground.

8. The power system of claim 1, wherein the power supply unit further comprises a filter capacitor connected between the input terminal of DC-DC rectifier and ground.
